(19) United States
(12) Patent Application Publication
(10) Pub. No.: US 2010/0184623 A1
(43) Pub. Date: Jul. 22, 2010

(54) GENE-ARRAY OPERATION CHIP DEVICE

(76) Inventors: Suz-Kai HSIUNG, Kaohsiung County (TW); Shiu-Ru LIN, Kaohsiung City (TW); Hui-Jen CHANG, Kaohsiung Hsien (TW)

Correspondence Address: OSTROLENK FABER GERB & SOFFEN, 1180 AVENUE OF THE AMERICAS, NEW YORK, NY, 100368403, US

(21) Appl. No.: 12/357,700

(22) Filed: Jan. 22, 2009

(51) Int. Cl. C40B 40/08

(52) U.S. Cl. 506/17

(57) ABSTRACT

A gene-array operation chip device includes a reaction chamber, and a plurality of inlet holes connected respectively to agitation channels for creating agitation currents within the reaction chamber. Each agitation channel has two ends respectively connected to one of the inlet holes and to the reaction chamber. The agitation channels are inclined with respect to radial directions about an axis of the reaction chamber. Preferably, a flow channel interconnecting two reaction chambers has a hydrophobic wall surface to limit a fluid from flowing naturally between the chambers. In an embodiment, the reaction chamber is a hybridization chamber provided with a membrane-array.

### BACKGROUND OF THE INVENTION

1. Field of the Invention

This invention relates to a chip device, more particularly to a gene-array operation chip device.

2. Description of the Related Art

Pretreatment, extraction, and purification of clinical samples are very important steps in a conventional process of gene analysis. For instance, pretreatment of biological cells, extraction of DNA (deoxyribonucleic acid) and RNA (ribonucleic acid) samples, and purification of the DNA and RNA samples are such steps. However, these steps are complicated and time-consuming. Manual operation of these steps may further lead to excessive loss of the clinical samples and inaccurate results of the gene analysis.

### SUMMARY OF THE INVENTION

The object of the present invention is to provide a gene-array operation chip device that can overcome the aforesaid drawbacks of the prior art.

According to one aspect of this invention, a gene-array operation chip device comprises: at least one reaction chamber; a plurality of inlet holes adapted to supply reactants into the reaction chamber; and a plurality of agitation channels for creating agitation currents within the reaction chamber. Each of the agitation channels has two ends respectively connected to one of the inlet holes and to the reaction chamber. The agitation channels are inclined with respect to radial directions about an axis of the reaction chamber.

According to another aspect of the invention, a chip device comprises: at least two reaction chambers; at least one flow channel interconnecting the two reaction chambers, and having a channel confining wall provided with a hydrophobic wall surface to limit a fluid from flowing naturally between the two reaction chambers; and at least one suction channel connected to one of the reaction chambers.

According to a further aspect of the invention, a gene-array operation chip device comprises: at least one treatment chamber to obtain a target to be tested from a sample; a hybridization chamber fluidly communicated with the treatment chamber to receive the target from the treatment chamber; and a membrane-array provided with a plurality of probes to react with the target in the hybridization chamber.

### BRIEF DESCRIPTION OF THE DRAWINGS

Other features and advantages of the present invention will become apparent in the following detailed description of the preferred embodiment of this invention, with reference to the accompanying drawings, in which:

FIG. 1 is a perspective view of the preferred embodiment of a gene-array operation chip device installed in an automatic detection system according to this invention;

FIG. 2 is an exploded perspective view of the preferred embodiment;

FIG. 3 is a schematic top view of the preferred embodiment;

FIG. 4 is a sectional view of the preferred embodiment taken along line IV-IV in FIG. 3;

FIG. 5 is a partly sectional view of the preferred embodiment taken along line V-V in FIG. 3; and

FIG. 6 is a partly sectional view of the preferred embodiment taken along line VI-VI in FIG. 3.

### DETAILED DESCRIPTION OF THE PREFERRED EMBODIMENT

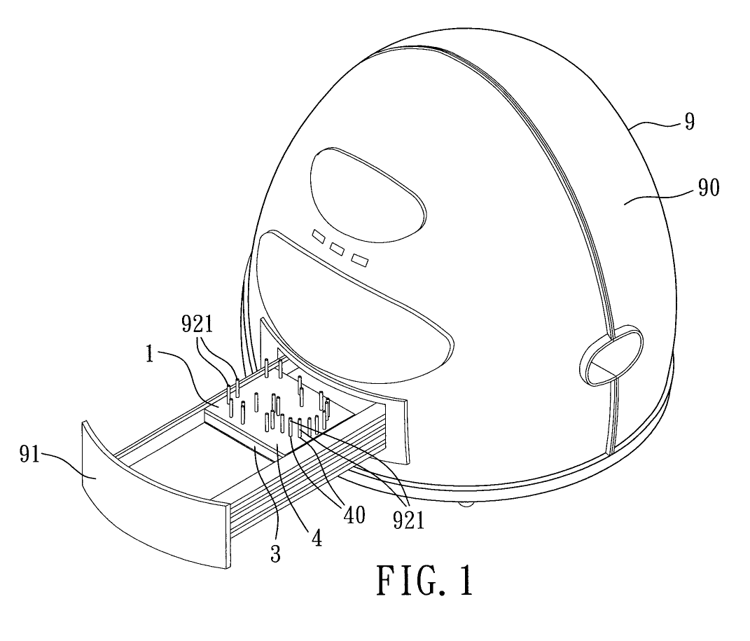

Referring to FIGS. 1, 2, and 3, there is shown a chip device, such as a gene-array operation chip device 1, embodying the present invention. The gene-array operation chip device 1 is suitable for installation in an automatic detection system 9.

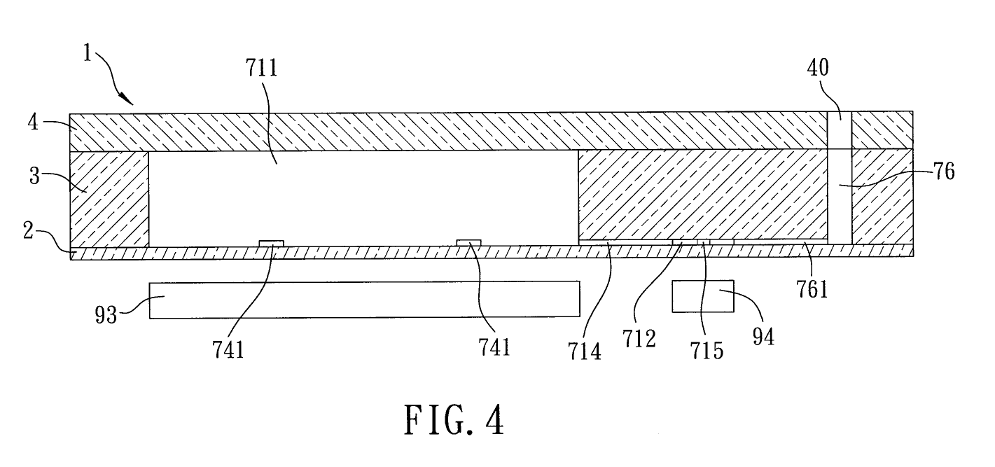

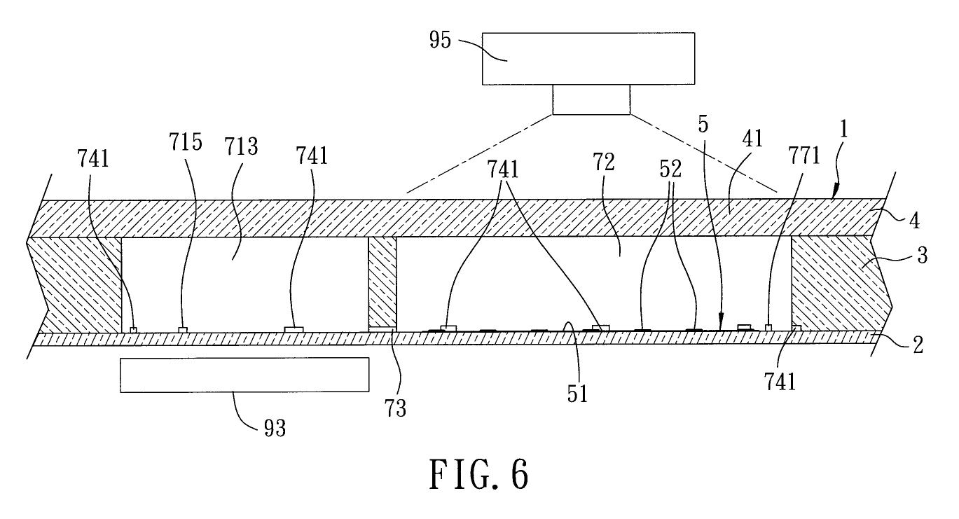

The automatic detection system 9 includes a fluid control unit (not shown) that is capable of connecting to the gene-array operation chip device 1 for controlling flow of samples and reactant, a magnetic force control unit 94 (shown in FIG. 4) that is capable of positioning a plurality of magnetic beads, a temperature control unit 93 (shown in FIG. 4) for controlling temperatures of fluids in the gene-array operation chip device 1, an image acquisition unit 95 (shown in FIG. 6) for acquiring an image of the gene-array operation chip device 1, and a central processing unit (not shown) for controlling the preceding units by virtue of a program.

The gene-array operation chip device 1 includes a base layer 2, a chamber layer 3, and a cover layer 4. A membrane-array 5 is disposed on top of the base layer 2.

The chamber layer 3 has a plurality of reaction chambers including a first treatment chamber 711, a second treatment chamber 712, a third treatment chamber 713, and a hybridization chamber 72. The chamber layer 3 further has a plurality of inlet holes 74, a plurality of agitation channels 741, a first flow channel 714, a second flow channel 715, a third flow channel 73, two first suction channels 761, and a second suction channel 771.

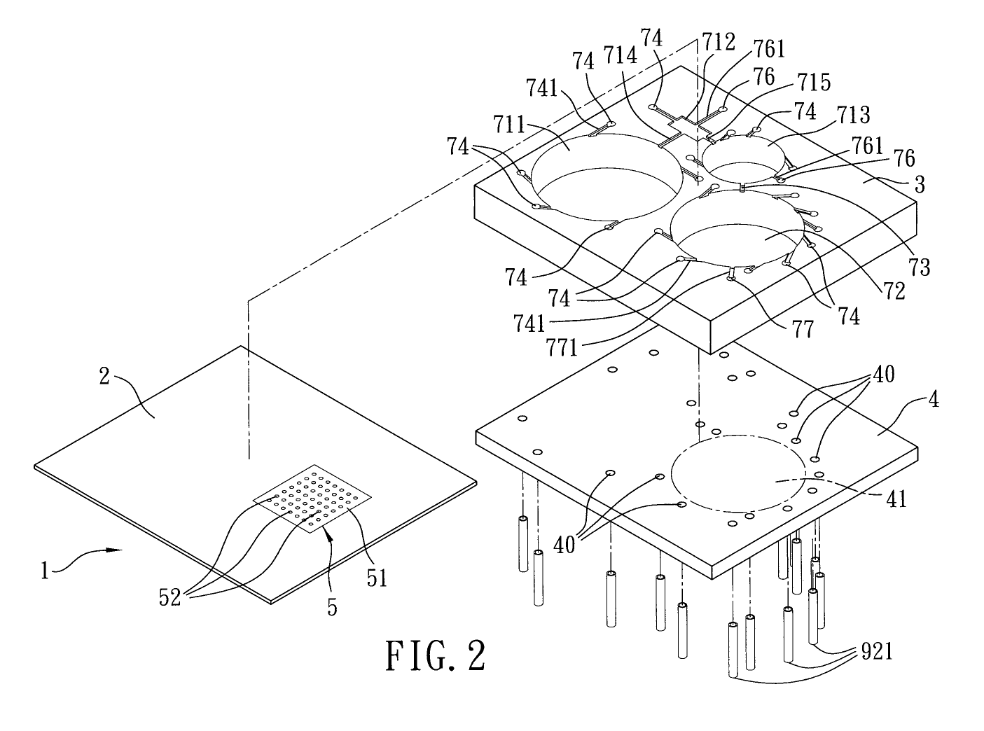

The first treatment chamber 711 extends through the top and bottom surfaces of the chamber layer 3, and has a round chamber wall. The second treatment chamber 712 is recessed from the bottom surface (facing upward as the chamber layer 3 is inverted in FIG. 2) of the chamber layer 3 and is in direct fluid communication with the first treatment chamber 711. The third treatment chamber 713 extends through the top and bottom surfaces of the chamber layer 3, has a round chamber wall, and is in direct fluid communication with the second treatment chamber 712 and the hybridization chamber 72. The hybridization chamber 72 extends through the top and bottom surfaces of the chamber layer 3, and has a round chamber wall.

The first flow channel 714 is recessed from the bottom surface (facing upward as the chamber layer 3 is inverted in FIG. 2) of the chamber layer 3, and interconnects the first and second treatment chambers 711,712. The second flow channel 715 is recessed from the bottom surface of the chamber layer 3, and interconnects the second and third treatment chambers 712,713. The third flow channel 73 is recessed from the bottom surface of the chamber layer 3, and interconnects the third treatment chamber 713 and the hybridization chamber 72. Each of the first, second, and third flow channels 714,715,73 has a channel confining wall that is provided with a hydrophobic wall surface to limit the fluid from flowing naturally between the first treatment chamber 711, the second treatment chamber 712, the third treatment chamber 713, and the hybridization chamber 72. The hydrophobic wall surface may be provided for the first, second, and third flow channels 714,715,73 by using a hydrophobic material to fabricate the chamber layer 3. Alternatively, a hydrophobic material may be applied as a coating to the channel confining walls of the first, second, and third flow channels 714,715,73 to form the hydrophobic wall surface. Examples of the hydrophobic materials include polydimethylsiloxane (PDMS) and polymethylmethacrylate (PMMA). However, the invention should not be limited thereto. Any other suitable method and material may be used to form the hydrophobic wall surface. It is noted that the volumes of the first, second, and third flow channels 714,715,73 are smaller than those of the first, second, and third treatment chambers 711,712,713, and the hybridization chamber 72.

Each of the inlet holes 74 is adapted to supply a reactant into a respective one of the first treatment chamber 711, the second treatment chamber 712, the third treatment chamber 713, and the hybridization chamber 72, and extends through the top and bottom surfaces of the chamber layer 3.

Each of the agitation channels 741 is recessed from the bottom surface of the chamber layer 3, and has two ends that are respectively connected to a respective one of the inlet holes 74 and to a respective one of the first treatment chamber 711, the third treatment chamber 713, and the hybridization chamber 72. According to the present invention, the agitation channels 741 are provided to create agitation currents or turbulences when the reactants from the inlet holes 74 flow through the agitation channels 741 and enter the first and third treatment chambers 711,713 and the hybridization chamber 72. The agitation channels 741 are inclined with respect to radial directions about an axis of the first or third treatment chambers 711,713 or the hybridization chamber 72. In this embodiment, each of the first and third treatment chambers 711,713 and the hybridization chamber 72 has an axis at the center of the round chamber wall thereof. Various samples and reagents can be rapidly mixed with each other in the first treatment chamber 711, the third treatment chamber 713, and the hybridization chamber 72 due to the agitation currents.

In particular, the inlet holes 74 are spaced apart angularly around the axes of the first and third treatment chambers 711,713 and the hybridization chamber 72. Similarly, the agitation channels 741 are spaced apart angularly around the axes of the first and third treatment chambers 711,713 and the hybridization chamber 72. Each group of the agitation channels 741 connected to one of the first and third treatment chambers 711,713 and the hybridization chamber 72 extend from the respective inlet holes 74 to the first or third treatment chambers 711,713 or the hybridization chamber 72 substantially along the same rotational direction, i.e., clockwise or counterclockwise direction.

Each of the first suction channels 761 is recessed from the bottom surface of the chamber layer 3, and is connected between a first suction hole 76 and a respective one of the second treatment chamber 712 and the third treatment chamber 713. The first suction hole 76 extends through the top and bottom surfaces of the chamber layer 3. The second suction channel 771 is recessed from the bottom surface of the chamber layer 3 and is connected between a second suction hole 77 and the hybridization chamber 72. The fluid control unit of the automatic detection system 9 is capable of exerting vacuum pumping by virtue of the first and second suction holes 76,77 and the first and second suction channels 761,771. Negative pressure can be applied to the second treatment chamber 712, the third treatment chamber 713, and the hybridization chamber 72 to provide suction forces. Via the suction forces, the fluids can be transported between the first and second treatment chambers 711,712, between the second and third treatment chambers 712,713, and between the third treatment chamber 713 and the hybridization chamber 72. Furthermore, via the suction forces, the fluids can be drawn into and drained out from the second treatment chamber 712, the third treatment chamber 713, and the hybridization chamber 72.

The cover layer 4 covers the top surface (facing downward in FIG. 2) of the chamber layer 3, and is formed with a plurality of through-holes 40 that extend through the top and bottom surfaces of the cover layer 4 and that are respectively in spatial communication with the inlet holes 74, the first suction holes 76, and the second suction hole 77. A transparent window 41 is provided in the cover layer 4 immediately above the hybridization chamber 72. The image acquisition unit 95 (shown in FIG. 6) is capable of acquiring an image of the membrane-array 5 through the transparent window 41.

The membrane-array 5 includes a base plate 51 that is adhered fixedly to the top surface of the base layer 2, and that is located within the hybridization chamber 72 and below the transparent window 41. The membrane-array 5 further includes a plurality of gene spots 52 that are connected to the top surface of the base plate 51, that are organized in a matrix array, and that are provided with a plurality of gene probes capable of presenting different colors upon reaction with target biomolecules. It is noted that the base plate 51 can be omitted and the membrane-array 5 or the gene spots 52 can be directly attached to the top surface of the base layer 2 in other embodiments.

The automatic detection system 9 further includes a case 90 and a carrier 91 (only shown in FIG. 1) to carry the gene-array operation chip device 1. The carrier 91 can be pushed into or pulled out from the case 90 to move the gene-array operation chip device 1 into or out from the case 90. The fluid control unit includes a plurality of pipes 921. When the gene-array operation chip device 1 is installed in the carrier 91 that is pulled out from the case 90, the pipes 921 are respectively inserted into the through-holes 40 of the cover layer 4. Therefore, the pipes 921 are respectively in spatial communication with the inlet holes 74, the first suction holes 76, and the second suction hole 77. The gene-array operation chip device 1 is then moved into the automatic detection system 9 for an analysis after the carrier 91 is pushed into the case 90. In this embodiment, the gene-array operation chip device 1 is used for analyzing mRNA (messenger RNA) molecules contained in trace amounts of circulating tumor cells in blood for the sake of explanation. It is noted that the gene-array operation chip device 1 can be used for analyzing different samples in other embodiments.

In this embodiment, the first treatment chamber 711 is used as a cell lysis chamber for lysis of a sample so as to obtain a target. The second treatment chamber 712 is used as a purification chamber for purification of the target from the cell lysis chamber. The third treatment chamber 713 is used as an amplification chamber for amplification of the purified target. The hybridization chamber 72 is able to receive the amplified target and permit the same to react with the probes.

Referring to FIGS. 2, 3, and 4, when in use, the fluid control unit is operated to inject a blood sample and a cell lysis reagent into the first treatment chamber 711 via the inlet holes 74 and the agitation channels 741 connected to the first treatment chamber 711. The blood sample and the cell lysis reagent are efficiently mixed with each other due to the agitation currents within the first treatment chamber 711. Under optimal temperatures regulated by the temperature control unit 93, circulating tumor cells in the blood sample are lysed to release mRNA molecules. Subsequently, magnetic beads, a binding buffer solution, and a washing buffer solution are injected into the first treatment chamber 711 via the inlet holes 74 and the agitation channels 741 connected to the first treatment chamber 711, and are efficiently mixed with the cell lysate solution owing to the agitation currents within the first treatment chamber 711. The mRNA molecules bond to the surfaces of the magnetic beads. On account of the hydrophobic wall surface of the first flow channel 714, the fluid in the first treatment chamber 711 cannot flow naturally into the second treatment chamber 712 by way of the first flow channel 714.

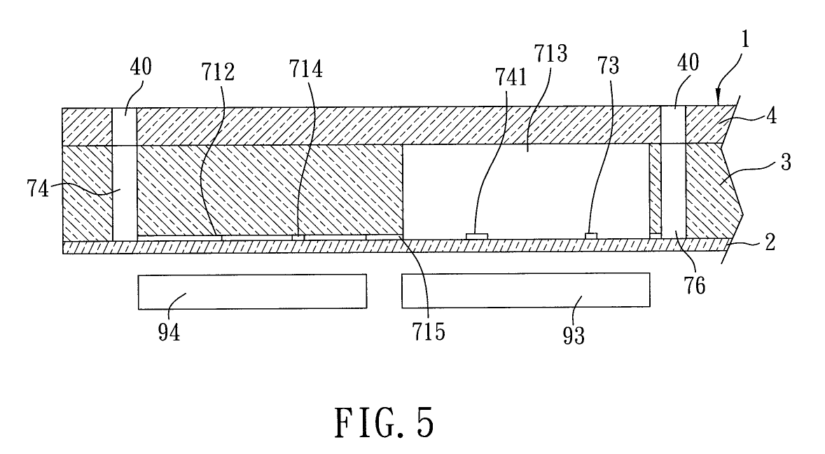

Referring to FIGS. 2, 3, and 5, when the vacuum pumping is operated through the first suction hole 76 and the first suction channel 761 connected to the second treatment chamber 712, and when one of the inlet holes 74 connected to the agitation channels 741 that are connected to the first treatment chamber 711 is opened to ambient atmosphere by the fluid control unit, a pressure difference is produced between the first treatment chamber 711 and the second treatment chamber 712, and the fluid in the first treatment chamber 711 flows into the second treatment chamber 712 through the first flow channel 714. At that time, the magnetic force control unit 94 is operated to exert a magnetic force that attracts the magnetic beads in the second treatment chamber 712 towards the top surface of the base layer 2, thereby immobilizing the magnetic beads in the fluid on the surface of the base layer 2. The fluid with no magnetic beads therein is drained out from the second treatment chamber 712 via the first suction hole 76 connected to the second treatment chamber 712. Consequently, the extraction and purification of the mRNA molecules are achieved.

Afterwards, an elution buffer solution is injected into the second treatment chamber 712 through the inlet hole 74 that is connected to the second treatment chamber 712, thereby dissolving the mRNA molecules and separating the mRNA molecules from the surfaces of the magnetic beads. When the vacuum pumping is operated through the first suction hole 76 connected to the third treatment chamber 712, the inlet hole 74 connected to the second treatment chamber 712 is opened to ambient atmosphere by the fluid control unit. A negative pressure is therefore produced in the third treatment chamber 713, thereby causing the fluid in the second treatment chamber 712 to flow into the third treatment chamber 713 through the second flow channel 715. Thus, the mRNA molecules are transferred from the second treatment chamber 712 to the third treatment chamber 713 together with the fluid flowing from the second treatment chamber 712.

Reagents required for reverse transcription and amplification are injected into the third treatment chamber 713 through the inlet holes 74 connected to the agitation channels 741 that are in turn connected to the third treatment chamber 713. The reagents and the fluid in the third treatment chamber 713 are efficiently mixed with each other due to the agitation currents within the third treatment chamber 713. Under optimal temperatures regulated by the temperature control unit 93, the mRNA molecules are reversely transcribed to cDNA (complementary DNA) molecules in the third treatment chamber 713. DIG (digoxigenin) molecules and required reagents are injected into the third treatment chamber 713 via the inlet holes 74 connected to the agitation channels 741 that are connected to the third treatment chamber 713. The DIG molecules bond to the cDNA molecules for labeling the cDNA molecules.

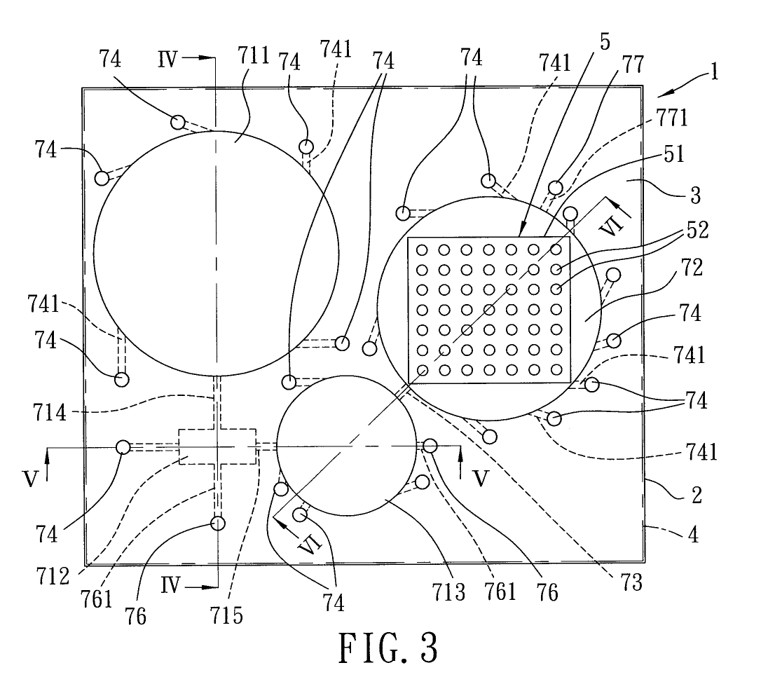

Referring to FIGS. 3 and 6, when the vacuum pumping is operated through the second suction hole 77 and the second suction channel 771 connected to the hybridization chamber 72, one of the inlet holes 74 connected to the agitation channels 741 that are connected to the third treatment chamber 713 is opened to ambient atmosphere by the fluid control unit. The negative pressure produced in the hybridization chamber 72 enables the fluid in the third treatment chamber 713 to flow into the hybridization chamber 72 through the third flow channel 73. The cDNA molecules labeled with the DIG molecules are transferred into the hybridization chamber 72 together with the fluid flowing from the third treatment chamber 713.

Required reagents for hybridization are injected into the hybridization chamber 72 through the inlet holes 74 connected to the agitation channels 741 that are connected to the hybridization chamber 72. The required reagents and the fluid in the hybridization chamber 72 are efficiently mixed with each other due to the agitation currents within the hybridization chamber 72. The hybridization of the labeled cDNA molecules and the probes on the gene spots 52 is accelerated due to the agitation currents as well. Color changes can be observed on the membrane-array 5. The waste fluid can be drained out from the hybridization chamber 72 by virtue of the second suction hole 77 and transferred to a waste container (not shown) in the automatic detection system 9.

The image acquisition unit 95 is used to acquire an image of the color changes on the gene spots 52 of the membrane-array 5 through the transparent window 41. Consequently, the mRNA molecules of the circulating tumor cells in the blood sample can be analyzed.

As described above, transport of the fluids between the first treatment chamber 711, the second treatment chamber 712, the third treatment chamber 713, and the hybridization chamber 72 is carried out by the suction forces exerted at the first and second suction holes 76,77. Alternatively, the transport of the fluids may be carried out by using external ducts of the fluid control unit.

The gene-array operation chip device 1 has the following advantages over the conventional technique of gene analysis: small volume, disposability, portability, requirement of a small amount of samples, low energy consumption, high accuracy of results, low production cost, and applicability to an automatic system for gene analysis. Pretreatment of clinical samples, extraction, purification, and labeling of desired biological molecules, and hybridization of the probes on the membrane-array 5 and the desired biological molecules can be efficiently achieved on a single gene-array operation chip device 1. Furthermore, shortening of reaction time, reduction of labor, minimization of human errors, and establishment of a standard operation for gene analysis can be accomplished.

While the present invention has been described in connection with what is considered the most practical and preferred embodiment, it is understood that this invention is not limited to the disclosed embodiment but is intended to cover various arrangements included within the spirit and scope of the broadest interpretation and equivalent arrangements.

What is claimed is:

1. A gene-array operation chip device, comprising:
at least one reaction chamber;
a plurality of inlet holes adapted to supply reactants into said reaction chamber; and
a plurality of agitation channels for creating agitation currents within said reaction chamber, each of said agitation channels having two ends respectively connected to one of said inlet holes and to said reaction chamber, said agitation channels being inclined with respect to radial directions about an axis of said reaction chamber.

2. The gene-array operation chip device of claim 1, wherein said agitation channels extend from said inlet holes to said reaction chamber substantially along the same rotational direction.

3. The gene-array operation chip device of claim 1, wherein said inlet holes are spaced apart angularly around said axis of said reaction chamber, and said agitation channels are respectively connected to said inlet holes and are connected to said reaction chamber at angularly spaced apart positions.

4. The gene-array operation chip device of claim 3, comprising a plurality of said reaction chambers including at least one treatment chamber and at least one hybridization chamber fluidly communicated with said treatment chamber, each of said treatment chamber and said hybridization chamber being connected to a plurality of said inlet holes through a plurality of said agitation channels.

5. The gene-array operation chip device of claim 4, comprising a plurality of said treatment chambers including a first treatment chamber, a second treatment chamber in direct fluid communication with said first treatment chamber, and a third treatment chamber in direct fluid communication with said second treatment chamber and said hybridization chamber.

6. The gene-array operation chip device of claim 5, wherein each of said first and third treatment chambers and said hybridization chamber has a round chamber wall.

7. The gene-array operation chip device of claim 5, further comprising a first flow channel interconnecting said first and second treatment chambers, a second flow channel interconnecting said second and third treatment chambers, and a third flow channel interconnecting said third treatment chamber and said hybridization chamber, each of said first, second and third flow channels having a channel confining wall provided with a hydrophobic wall surface to limit the reactants from flowing naturally between said first, second, third treatment and hybridization chambers.

8. The gene-array operation chip device of claim 7, further comprising a plurality of suction channels respectively connected to said second and third treatment chambers and said hybridization chamber.

9. The gene-array operation chip device of claim 8, further comprising a membrane-array provided with a plurality of probes thereon and arranged to allow the reactants in said hybridization chamber to react with said probes.

10. A chip device, comprising
at least two reaction chambers;
at least one flow channel interconnecting said two reaction chambers, and having a channel confining wall provided with a hydrophobic wall surface to limit a fluid from flowing naturally between said two reaction chambers; and
at least one suction channel connected to one of said reaction chambers.

11. The chip device of claim 10, further comprising at least one inlet hole connected to the other one of said reaction chambers.

12. A gene-array operation chip device, comprising:
at least one treatment chamber to obtain a target to be tested from a sample;
a hybridization chamber fluidly communicated with said treatment chamber to receive the target from said treatment chamber; and
a membrane-array provided with a plurality of probes to react with the target in said hybridization chamber.

13. The gene-array operation chip device of claim 12, comprising a plurality of said treatment chambers including a cell lysis chamber for lysis of the sample so as to obtain the target, a purification chamber fluidly communicated with said cell lysis chamber for purification of the target from said cell lysis chamber, and an amplification chamber communicated with said purification chamber for amplification of the purified target, said hybridization chamber being connected to said amplification chamber to receive the amplified target and to permit the amplified target to react with said probes.

14. The gene-array operation chip device of claim 12, further comprising a base layer, a chamber layer attached to a top surface of said base layer and defining said treatment chamber and said hybridization chamber, and a cover layer disposed on top of said chamber layer, said membrane-array being fixed to said top surface of said base layer and being located within said hybridization chamber.

15. The gene-array operation chip device of claim 14, wherein said cover layer covers said treatment chamber and said hybridization chamber, and has a transparent window disposed immediately above said hybridization chamber and said membrane-array.
